(19) United States
(12) Patent Application Publication
(10) Pub. No.: US 2022/0312783 A1
(43) Pub. Date: Oct. 6, 2022

(54) METHOD OF PREPARING A PRESERVED FRUIT COMPOSITION

(71) Applicant: Purac Biochem B.V., Gorinchem (NL)

(72) Inventors: Catalin IANCU, Gorinchem (NL); Prita PRITAWARDANI, Gorinchem (NL)

(21) Appl. No.: 17/843,567

(22) Filed: Jun. 17, 2022

Related U.S. Application Data
(63) Continuation of application No. PCT/EP2020/086246, filed on Dec. 15, 2020.

(30) Foreign Application Priority Data
Dec. 19, 2019 (EP) 19218188.1

(51) Int. Cl. A23B 7/154; A23L 19/00; A23L 3/3508

(52) U.S. Cl. CPC A23B 7/154; A23L 19/03; A23L 3/3508; A23V 2002/00

(57) ABSTRACT

The invention relates to a method of preparing a preserved fruit composition having a Brix value of 10° to 60°, a water content of at least 20 wt. % and a pH in the range of 3.0 to 4.2, said method comprising:
providing a non-preserved fruit composition having a total water content of at least 15 wt. % and comprising not more than 85 wt. % of dry matter, said dry matter comprising 30-92% by weight of dry matter of sugar selected from fructose, glucose, sucrose and combinations thereof and 8-80% by weight of dry matter of non-sugar dry fruit matter;
combining the non-preserved fruit composition with an acetate buffer having a pH in the range of 3.0 to 5.7 to prepare a buffered fruit composition, said acetate buffer containing 10-50 wt. % of dissolved acetate in the form of dissolved acetic acid and dissolved acetate anion, and;
if needed, adding water and/or acidulant to the buffered fruit composition to achieve a water content of at least 20 wt. % and a pH in the range of 3.0 to 4.2.

The preservation method of the present invention enables effective prevention of microbial spoilage in fruit compositions without negatively impacting the organoleptic properties of the product.

### CROSS-REFERENCE TO RELATED APPLICATIONS

The present application is a continuation application of PCT/EP2020/086246 filed Dec. 15, 2020, which claims priority to EP 19218188.1 filed Dec. 19, 2019 the entire contents of both which are incorporated herein by reference.

### TECHNICAL FIELD OF THE INVENTION

The present invention relates to a method of preparing a preserved fruit composition having a Brix value of 10° to 60°, a water content of at least 20 wt. % and a pH in the range of 3.0-4.2, said method comprising addition of an acetate buffer. Examples of fruit compositions that can be preserved in this manner include fruit preparations, fruit fillings, fruit purees, fruit sauces, fruit preserves, fruit juices and concentrated fruit juices.

The invention also relates to the use of an acetate buffer for preserving a fruit composition.

Acetate buffer can suitably be used to extend the shelf life of fruit compositions, by preventing or slowing down microbial spoilage. Acetate buffer can be used as a clean label alternative for preservatives such as potassium sorbate and sodium benzoate. Furthermore, acetate buffer can be applied in fruit compositions without adversely affecting the taste or appearance of the product.

### BACKGROUND OF THE INVENTION

Food spoilage is a major issue for the food industry, leading to food waste, substantial economic losses for manufacturers and consumers, and a negative impact on brand names. Microbiological spoilage is caused by a wide variety of bacteria, moulds and yeasts. Spoilage by yeast and moulds is favored in products with low pH, generally 5.5 or lower, high water content and by the presence of sugars, organic acids and other easily metabolized carbon sources.

In order to avoid microbial spoilage and thus extend product shelf life, different treatments (including the use of fungicides and chemical preservatives, such as benzoate, sorbate, nitrate, nitrite, and sulfites) are used. In parallel, public authorities encourage the food industry to limit the use of these chemical compounds and develop natural methods for food preservation. This is accompanied by a strong societal demand for ‘clean label’ food products as consumers are looking for more natural, less severely processed and safer products. Consumers want to know the composition of their food. Therefore, they pay more attention to the product label and prefer short, clean and clear labels, with mainly natural ingredients and ingredient names that they know and understand.

Verdad Ovvio 410 is a vinegar based product used for natural preservation in chilled foods like deli-style salads, dips and spreads. Verdad Ovvio 410 extends the shelf life naturally and enhances key savory notes.

WO 2019/038681 relates to natural food preservatives selected from the group comprising essential oil of a plant, an organic acid and combinations thereof. This document describes in the examples a preparation of a preservative for jam in which in a ribbon mixture clove bud oil 30 g, lactic acid 250 g, citric acid 193 g, cardamom extract 7 g, natamycin 70 g, maltodextrin 200 g, and silica 250 g was taken and mixed well. About 1000 g of uniformly mixed powder preservative formulation for fruit jam was obtained.

U.S. Pat. No. 5,624,698 describes a method for stabilizing beverage fountain syrup compositions comprising 0.2-3% of a dispersed oil phase and having a Brix value of 30° to 70° consisting essentially of incorporating into said syrup compositions 0.02-0.3% of xanthan gum and 0.2-0.10% of a modified food starch, wherein the ratio of modified food starch to oil is from about 0.1 to about 0.4.

### SUMMARY OF THE INVENTION

The inventors have developed a method of preparing a preserved fruit composition, which method comprises addition of an acetate buffer. More particularly the invention relates to a method of preparing a preserved fruit composition having a Brix value of 10° to 60°, a water content of at least 20 wt. % and a pH in the range of 3.0 to 4.2, said method comprising:
providing a non-preserved fruit composition having a total water content of at least 15 wt. % and comprising not more than 85 wt. % of dry matter, said dry matter comprising 30-92% by weight of dry matter of sugar selected from fructose, glucose, sucrose and combinations thereof and 8-80% by weight of dry matter of non-sugar dry fruit matter;
combining the non-preserved fruit composition with an acetate buffer having a pH in the range of 3.0 to 5.7 to prepare a buffered fruit composition, said acetate buffer containing 10-50 wt. % of dissolved acetate in the form of dissolved acetic acid and dissolved acetate anion, and;
if needed, adding water and/or acidulant to the buffered fruit composition to achieve a water content of at least 20 wt. % and a pH in the range of 3.0 to 4.2.

The preservation method of the present invention enables effective prevention of microbial spoilage in fruit compositions without negatively impacting the organoleptic properties of the product. The use of an acetate buffer offers the additional advantage that it can be applied in the form of a “clean label” ingredient, for instance if vinegar is used as an ingredient.

The present method optionally comprises the step of adding water and/or acidulant after the non-preserved fruit composition has been combined with the acetate buffer. A preserved fruit concentrate may, for instance, be prepared in accordance with the present invention by adding acetate buffer to a 60° Brix fruit juice concentrate having a pH of 4.2 followed by addition of water to reduce the Brix value to 15° and addition of acidulant to reduce the pH of diluted juice concentrate to pH 3.6.

The invention further relates to the use of an acetate buffer as described above for preserving a fruit composition.

### DETAILED DESCRIPTION OF THE INVENTION

Accordingly, a first aspect of the invention relates to a method of preparing a preserved fruit composition having a Brix value of 10° to 60°, a water content of at least 20 wt. % and a pH in the range of 3.0 to 4.2, said method comprising:
providing a non-preserved fruit composition having a total water content of at least 15 wt. % and comprising not more than 85 wt. % of dry matter, said dry matter comprising 30-92% by weight of dry matter of sugar selected from fructose, glucose, sucrose and combinations thereof and 8-80% by weight of dry matter of non-sugar dry fruit matter;
combining the non-preserved fruit composition with an acetate buffer having a pH in the range of 3.0 to 5.7 to prepare a buffered fruit composition, said acetate buffer containing 10-50 wt. % of dissolved acetate in the form of dissolved acetic acid (CH₃COOH) and dissolved acetate anion (CH₃COO⁻), and;
if needed, adding water and/or acidulant to the buffered fruit composition to achieve a water content of at least 20 wt. % and a pH in the range of 3.0 to 4.2.

The term “fruit composition” as used herein refers to sweet food products that contain fruit material in the form of fruit pieces, fruit puree and/or fruit juice, and that may contain added sugar and optionally some minor ingredients. Non-limiting examples of fruit compositions according to the invention include fruit preparations, fruit fillings, fruit purees, fruit sauces, fruit preserves, fruit juices and fruit juice concentrates.

The term “non-sugar dry fruit matter” as used herein refers to the dry matter of fruit that is contained in the fruit composition, except for the sugar component of the fruit, i.e. the combination of fructose, glucose and sucrose.

Whenever reference is made herein to “water content” or “total water content”, what is meant is the total water content including water that is contained, for instance, in fruit pieces.

The Brix value of the preserved fruit composition equals the Brix of the liquid that is contained in the composition. In the case of fruit juice, the Brix value equals the Brix value of the fruit juice. In case of a fruit filling containing fruit pieces and a liquid phase, the Brix value equals the Brix value of the liquid phase. The Brix value is determined at 20° C. using a refractometer.

Whenever reference is made herein to fruits, unless indicated otherwise, what is meant is the fleshy seed-associated structures of a plant that are sweet or sour, and edible in the raw state.

In a preferred embodiment the non-sugar dry fruit matter originates from fruit selected from the group consisting of apple, cherry, banana, grape, lemon, lime, orange, mango, apricot, pineapple, blueberry, strawberry, raspberry, mulberry, blackcurrant, redcurrant, plum, fig, pear, mandarin, grapefruit, peach, passion fruit, melon, kiwi, guava, pawpaw, coconut, litchi and combinations thereof.

The preserved fruit composition of the present invention preferably has a Brix value of at least 12°, more preferably a Brix value in the range of 13-55°, most preferably in the range of 15-40°.

The water content of the preserved fruit composition preferably lies in the range of 60-88 wt. %, more preferably in the range of 65-85 wt. %, most preferably in the range of 68-82 wt. %.

The preserved fruit composition preferably has a pH in the range of 3.2-4, more preferably in the range of 3.3-3.8.

In a preferred embodiment the preserved fruit composition contains 4-50 wt. %, more preferably 6-40 wt. % and most preferably 7-32 wt. % of sugar selected from fructose, glucose, sucrose and combinations thereof.

In a further preferred embodiment the preserved fruit composition contains 3-40 wt. %, more preferably 5-30 wt. %, most preferably 8-20 wt. % of non-sugar dry fruit matter.

The combination of fructose, glucose, sucrose and non-sugar dry matter typically constitutes at least 10 wt. %, more preferably 12-70 wt. %, most preferably 14-35 wt. % of the preserved fruit composition.

The preserved fruit composition preferably comprises 0.3-4 wt. %, more preferably 0.5-3.2 wt. % dissolved acetate in the form of dissolved acetic acid and dissolved acetate anion.

The dissolved acetate can be obtained from acetic acid containing natural products such as vinegar as for instance described in EP3122865B1.

Besides sugar, non-sugar dry fruit matter and water, the preserved fruit composition may suitably contain other ingredients such as flavouring, colouring, thickening agents, gelling agents, vitamins, minerals and anti-oxidants.

In a preferred embodiment the preserved fruit composition has a water activity of at least 0.8, more preferably of at least 0.85, most preferably of at least 0.9.

The non-preserved fruit composition that is employed in the present method preferably has a total water content of at least 30 wt. %, more preferably of at least 45 wt. %, most preferably of at least 60 wt. %

The non-preserved fruit composition preferably comprises not more than 70 wt. % of dry matter, more preferably 12-60 wt. % of dry matter, most preferably 15-50 wt. % of dry matter.

According to a particularly preferred embodiment, the non-preserved fruit composition comprises at least 30 wt. % of fruit pieces, more preferably at least 45 wt. %, most preferably at least 55 wt. % of fruit pieces having a weight of at least 0.1 gram.

The aforementioned fruit pieces preferably are pieces of a fruit selected from apple, cherry, banana, grape, lemon, lime, orange, mango, apricot, pineapple, blueberry, strawberry, raspberry, mulberry, blackcurrant, redcurrant, plum, fig, pear, mandarin, grapefruit, peach, passion fruit, melon, kiwi, guava, pawpaw, coconut, litchi and combinations thereof.

The total water content of the non-preserved fruit composition preferably lies in the range of 40-90 wt. %, more preferably in the range of 60-88 wt. %, and most preferably in the range of 65-86 wt. %.

The non-preserved fruit composition preferably comprises 40-90% by weight of dry matter of sugar selected from fructose, glucose, sucrose and combinations thereof and 10-60% by weight of dry matter of non-sugar dry fruit matter. More preferably, the non-preserved fruit composition preferably comprises 45-80% by weight of dry matter of sugar selected from fructose, glucose, sucrose and combinations thereof and 20-55% by weight of dry matter of non-sugar dry fruit matter.

Fructose is preferably contained in the non-preserved fruit composition in a concentration of at least 10% by weight of dry matter, more preferably in a concentration of 12-45 w % by weight of dry matter, most preferably in a concentration of 15-40 wt. % by weight of dry matter.

The acetate buffer that is employed in the present method preferably contains 15-45 wt. %, more preferably 17.5-40 wt. % and most preferably 18-35 wt. % of dissolved acetate in the form of dissolved acetic acid and dissolved acetate anion.

According to a particularly preferred embodiment, the acetate buffer has a pH in the range of 3.2-5.5.

Preferably, the acetate buffer contains (i) cations selected from potassium, sodium cations, calcium cations and combinations thereof and (ii) dissolved acetate in a molar ratio of 1:25 to 1:1.5, preferably a molar ratio of 1:20 to 1:2.

According to a particularly preferred embodiment, sodium cations, calcium cations and potassium cations together constitute at least 90 mol %, more preferably at least 90 mol % of the dissolved cations in the acetate buffer.

According to a further preferred embodiment, potassium cations constitute at least 60 mol % of the dissolved cations, more preferably at least 75 mol % and most preferably at least 90 mol %.

According to another preferred embodiment, acetate anions represent at least 80 mol. % of the dissolved anions in the acetate buffer.

In one advantageous embodiment, acetate anions represent at least 80 mol. % of the dissolved anions and potassium cations represent at least 90 mol % of the dissolved cations in the acetate buffer.

In an alternative advantageous embodiment, the acetate buffer contains preferably 5-30 wt. %, more preferably 10-25 wt. %, most preferably 15-20 wt. % of dissolved organic acid in the form of dissolved protonated organic acid and dissolved organic acid anion, said organic acid being selected from lactic acid, propionic acid, malic acid, ascorbic acid, citric acid, fumaric acid, adipic acid, tartaric acid and combinations thereof. More preferably, the organic acid is selected from lactic acid, propionic acid and combinations thereof. Most preferably the organic acid is lactic acid.

The acetate buffer containing dissolved organic acid preferably contains the dissolved acetate and the dissolved organic acid in a molar ratio of 1:1 to 5:1, more preferably in a molar ratio of 1.3:1 to 3:1.

The acetate buffer containing dissolved organic acid preferably contains (i) cations selected from sodium cations, potassium cations, calcium cations and combinations thereof and (ii) the combination of dissolved acetate and the dissolved organic acid in a molar ratio of 1:25 to 1:1.5, more preferably in a molar ratio of 1:20 to 1:2.

According to a particularly preferred embodiment the acetate buffer contains 5-30 wt. %, more preferably 10-25 wt. %, most preferably 15-20 wt. % of dissolved lactic acid in the form of dissolved protonated lactic acid and dissolved lactate anion.

The acetate buffer containing dissolved lactic acid preferably contains the acetate anions and the lactate anions in a molar ratio of 1:1 to 5:1, more preferably in a molar ratio of 1.3:1 to 3:1.

The acetate buffer containing dissolved lactic acid preferably contains (i) cations selected from sodium cations, potassium cations, calcium cations and combinations thereof and (ii) the combination of dissolved acetate and the dissolved lactic acid in a molar ratio of 1:25 to 1:1.5, more preferably in a molar ratio of 1:20 to 1:2.

According to another preferred embodiment the non-preserved fruit composition is combined with an amount of acetate buffer that provides per kilogram of the preserved fruit preparation 25-300 mmol of dissolved acetate in the form of dissolved acetic acid and acetate anion, more preferably 40-250 mmol and most preferably 50-200 mmol.

According to yet another preferred embodiment the non-preserved fruit composition is combined with an amount of acetate buffer that provides per kilogram of the preserved fruit preparation 25-300 mmol of the combination of (i) dissolved acetate in the form of dissolved acetic acid and acetate anion and (ii) dissolved organic acid in the form of dissolved protonated organic acid and dissolved organic acid anion, more preferably 40-250 mmol and most preferably 50-200 mmol.

In the present method, preferably 100 parts by weight of the non-preserved fruit composition are combined with 0.5 to 10 parts by weight of the acetate buffer, more preferably 100 parts by weight of the fruit composition are combined with 1 to 9 parts by weight of the acetate buffer, most preferably 100 parts by weight of the fruit composition are combined with 2 to 8 parts by weight of the acetate buffer.

A further aspect of the invention relates to the use of acetate buffer according to the invention for preserving a fruit composition.

According to a preferred embodiment, the acetate buffer according to the invention is used to prevent or retard microbial spoilage, more preferably to prevent or retard growth of mould and/or yeast.

The invention is further illustrated by the following non-limiting examples.

### EXAMPLES

### Example 1

Acetate buffers according to the invention were prepared according to the table below:

TABLE 1
Acetate buffers according to the invention

| | | |
|---|---|---|
| Components | Buffer 1 | Buffer 2 |

| PURAC ® FCC 80 | 22.5 | wt. % | — | |
|---|---|---|---|---|
| Acetic acid, FCC, FG | 11.67 | wt. % | 19.57 | wt. % |
| Potassium acetate, anhydrous | 13.96 | wt. % | 9.02 | wt. % |
| NaOH 50% | 5.80 | wt. % | — | |
| Water | 46.08 | wt. % | 71.41 | wt. % |
| total | 100 | wt. % | 100 | wt. % |

| | | |
|---|---|---|
| pH | 4.6 | 4.2 |

PURAC® FCC 80 (Corbion, the Netherlands) is a product containing 80% lactic acid. Acetic acid FCC, FG is glacial acetic acid with a purity of at least 99.5% (Merck) and potassium acetate is an anhydrous product with a purity of more than 99% (ACROS).

### Example 2

The acetate buffers described in Example 1 were tested as clean label preservatives in bakery fruit fillings of 25° (72 wt. % water) and 34° Brix (63 wt. % water). The bakery fruit filling of 25° Brix was a commercially available in the Netherlands (product name: “Taart Vlaaifruit”, supplier name: HAK), containing 51% fruit (strawberry, blackberry, blackcurrant, cherry as entire berries, not diced or sliced), water, sugar, modified corn starch and natural aroma. The bakery fruit filling of 34° Brix was obtained by adding sugar to the product with a Brix of 25°.

The acetate buffers were added to the fruit filling samples in different concentrations, following which the fruit filling was inoculated with cocktails of either yeast or mould. The samples were incubated at 20° C. and microbial growth was monitored over time.

Challenge Study 1

In this study, the efficacy of the acetate buffers according to the invention was tested at pH 3.2 and pH 3.5 (pH adjusted using 1M HCl and 1M NaOH) against a cocktail of yeast. The samples were inoculated with approximately 3 log CFU/g of a cocktail comprising Pichia membranefaciens, Saccharomyces cerevisiae and Rhodotorula mucilagenosa. Subsequently, the samples were incubated at 20° C. and monitored over time. The results are shown in Table 2 below.

TABLE 2
Challenge study 1

| # | Preservative | Brix | pH | Results |
|---|---|---|---|---|
| 1 | 2.48% Buffer 1 | 25° | 3.2 | Prevention of yeast outgrowth |
| | | | | for >50 days¹ |
| 2 | 2% Buffer 2 | 25° | 3.2 | Prevention of yeast outgrowth |
| | | | | for >50 days¹ |
| 3 | 0.1% K-sorbate* | 25° | 3.2 | Prevention of yeast outgrowth |
| | | | | for 35 days |
| 4 | No preservative | 25° | 3.2 | Absence of inhibition effect |
| 5 | 2.48% Buffer 1 | 25° | 3.5 | Prevention of yeast outgrowth |
| | | | | for >50 days¹ |
| 6 | 2% Buffer 2 | 25° | 3.5 | Prevention of yeast outgrowth |
| | | | | for >50 days¹ |
| 7 | 0.1% K-sorbate* | 25° | 3.5 | Prevention of yeast outgrowth |
| | | | | for 35 days |
| 8 | No preservative | 25° | 3.5 | Absence of inhibition effect |

*1000 ppm (0.1%) is the maximum concentration allowed by the EU regulatory bodies.
¹monitoring stopped after 50 days

Challenge Study 2

In this study, the efficacy of the preservatives according to the invention was tested at pH 3.2 and pH 3.5 (pH adjusted using 1M HCl and 1M NaOH) against a cocktail of mould. The samples were inoculated with approximately 3.75 log spores/g of a cocktail comprising Aspergillus niger, Talaromyces sp. and Neosartorya spinosa. Subsequently, the samples were incubated at 20° C. and monitored over time. The results are shown in Table 3 below.

TABLE 3
Challenge study 2

| # | Preservative | Brix | pH | Results |
|---|---|---|---|---|
| 9 | 1.24% Buffer 1 | 25° | 3.2 | Prevention of mould outgrowth |
| | | | | for >45 days¹ |
| 10 | 2.48% Buffer 1 | 25° | 3.2 | Prevention of mould outgrowth |
| | | | | for >45 days¹ |
| 11 | 1% Buffer 2 | 25° | 3.2 | Prevention of mould outgrowth |
| | | | | for 8 days |
| | | | | followed by low² growth rates |
| | | | | for >32 days¹ |
| 12 | 2% Buffer 2 | 25° | 3.2 | Prevention of mould outgrowth |
| | | | | for >45 days¹ |
| 13 | 0.1% K-sorbate* | 25° | 3.2 | Prevention of mould outgrowth |
| | | | | for 7 days followed by normal² |
| | | | | growth |
| 14 | No preservative | 25° | 3.2 | Absence of inhibition effect |
| 15 | 1.24% Buffer 1 | 25° | 3.5 | Prevention of mould outgrowth |
| | | | | for >45 days¹ |
| 16 | 2.48% Buffer 1 | 25° | 3.5 | Prevention of mould outgrowth |
| | | | | for >45 days¹ |
| 17 | 1% Buffer 2 | 25° | 3.5 | Prevention of mould outgrowth |
| | | | | for >45 days¹ |
| 18 | 2% Buffer 2 | 25° | 3.5 | Prevention of mould outgrowth |
| | | | | for >45 days¹ |
| 19 | 0.1% K-sorbate* | 25° | 3.5 | Prevention of mould outgrowth |
| | | | | for 13 days followed by normal² |
| | | | | growth |
| 20 | No preservative | 25° | 3.5 | Mould outgrowth from day 3 on |

*1000 ppm (0.1%) is the maximum concentration allowed by the EU regulatory bodies.
¹monitoring stopped after 45 days
²in comparison to non-preserved sample

Challenge Study 3

In this study, the efficacy of the preservatives according to the invention was tested at pH 3.8 (pH adjusted using 1M HCl and 1M NaOH) and at different degrees Brix against cocktails of either yeast or mould. The samples inoculated with yeast received approximately 3 log CFU/g of a cocktail comprising Saccharomyces bayanus, Saccharomyces cerevisiae and Rhodotorula mucilagenosa. The samples inoculated with mould received approximately 3.75 log spores/g of a cocktail comprising Aspergillus niger, Talaromyces sp. and Neosartorya spinosa. After inoculation, the samples were incubated at 20° C. and monitored over time. The results are shown in Table 4 below.

TABLE 4
Challenge study 3

| # | Preservative | Brix | pH | Inoculum | Results |
|---|---|---|---|---|---|
| 21 | 2.48% Buffer 1 | 25° | 3.8 | Yeast | Low² growth rates until |
| | | | | | day 6 |
| 22 | 2% Buffer 2 | 25° | 3.8 | Yeast | Low² growth rates until |
| | | | | | day 6 |
| 23 | 0.1% K-sorbate* | 25° | 3.8 | Yeast | Prevention of yeast |
| | | | | | outgrowth for >24 days¹ |
| 24 | No | 25° | 3.8 | Yeast | Absence of inhibition |
| | preservative | | | | effect |
| 25 | 2.48% Buffer 1 | 34° | 3.8 | Yeast | Very low² growth rates |
| | | | | | for >12 days³ |
| 26 | 2% Buffer 2 | 34° | 3.8 | Yeast | Low² growth rates |
| | | | | | for >12 days³ |
| 27 | 0.1% K-sorbate* | 34° | 3.8 | Yeast | Prevention of yeast |
| | | | | | outgrowth for >12 days³ |
| 28 | No | 34° | 3.8 | Yeast | Absence of inhibition |
| | preservative | | | | effect |
| 29 | 2.48% Buffer 1 | 25° | 3.8 | Mould | Prevention of mould |
| | | | | | outgrowth for >28 days⁴ |
| 30 | 2% Buffer 2 | 25° | 3.8 | Mould | Prevention of mould |
| | | | | | outgrowth for >28 days⁴ |
| 31 | 0.1% K-sorbate* | 25° | 3.8 | Mould | Prevention of mould |
| | | | | | outgrowth for 6 days |
| | | | | | followed by normal² |
| | | | | | growth |
| 32 | No | 25° | 3.8 | Mould | Absence of inhibition |
| | preservative | | | | effect |
| 33 | 1.24% Buffer 1 | 34° | 3.8 | Mould | Prevention of mould |
| | | | | | outgrowth for >12 days³ |
| 34 | 2.48% Buffer 1 | 34° | 3.8 | Mould | Prevention of mould |
| | | | | | outgrowth for >12 days³ |
| 35 | 1% Buffer 2 | 34° | 3.8 | Mould | Prevention of mould |
| | | | | | outgrowth for >12 days³ |
| 36 | 2% Buffer 2 | 34° | 3.8 | Mould | Prevention of mould |
| | | | | | outgrowth for >12 days³ |

*1000 ppm (0.1%) is the maximum concentration allowed by the EU regulatory bodies.
¹monitoring stopped after 24 days
²in comparison to correspondent non-preserved sample
³monitoring stopped after 12 days
⁴monitoring stopped after 28 days

1. A method of preparing a preserved fruit composition having a Brix value of 10° to 60°, a water content of at least 20 wt. % and a pH in the range of 3.0 to 4.2, the method comprising:
(a) providing a non-preserved fruit composition having a total water content of at least 15 wt. % and comprising not more than 85 wt. % of dry matter, the dry matter comprising 30-92% by weight of dry matter of sugar selected from fructose, glucose, sucrose and combinations thereof and 8-80% by weight of dry matter of non-sugar dry fruit matter;
(b) combining the non-preserved fruit composition with an acetate buffer having a pH in the range of 3.0 to 5.7 to obtain a buffered fruit composition, the acetate buffer comprising 10-50 wt. % of dissolved acetate in the form of dissolved acetic acid and dissolved acetate anion, and;
(c) optionally, adding water and/or acidulant to the buffered fruit composition thereby obtaining a water content of at least 20 wt. % and a pH in the range of 3.0 to 4.2.

2. The method according to claim 1, wherein the acetate buffer comprises 15-45 wt. % of dissolved acetate in the form of dissolved acetic acid and dissolved acetate anion.

3. The method according to claim 1, wherein the acetate buffer has a pH in the range of 3.2 to 5.5.

4. The method according to claim 1, wherein the acetate buffer comprises (i) cations selected from potassium, sodium cations, calcium cations and combinations thereof and (ii) dissolved acetate in a molar ratio of 1:25 to 1:1.5.

5. The method according to claim 4, wherein the acetate buffer comprises (i) cations selected from potassium, sodium cations, calcium cations and combinations thereof and (ii) dissolved acetate in a molar ratio of 1:20 to 1:2.

6. The method according to claim 1, wherein acetate anion represents at least 80 mol. % of the dissolved anions in the acetate buffer and potassium cations represent at least 90 mol. % of the dissolved cations in the acetate buffer.

7. The method according to claim 1, wherein the acetate buffer comprises 5-30 wt. % of dissolved organic acid in the form of dissolved protonated organic acid and dissolved organic acid anion, the organic acid being selected from lactic acid, propionic acid, malic acid, ascorbic acid, citric acid, fumaric acid, adipic acid, tartaric acid and combinations thereof.

8. The method according to claim 7, wherein the acetate buffer comprises dissolved acetate and the dissolved organic acid in a molar ratio of 1:1 to 5:1.

9. The method according to claim 8, wherein the acetate buffer comprises dissolved acetate and the dissolved organic acid in a molar ratio of 1.3:1 to 3:1.

10. The method according to claim 7, wherein the acetate buffer comprises (i) cations selected from sodium cations, potassium cations, calcium cations and combinations thereof and (ii) the combination of dissolved acetate and the dissolved organic acid in a molar ratio of 1:25 to 1:1.5.

11. The method according to claim 10, wherein the acetate buffer comprises (i) cations selected from sodium cations, potassium cations, calcium cations and combinations thereof and (ii) the combination of dissolved acetate and the dissolved organic acid in a molar ratio of 1:20 to 1:2.

12. The method according to claim 7, wherein the organic acid is lactic acid.

13. The method according to claim 1, wherein the non-preserved fruit composition is combined with an amount of acetate buffer that provides per kilogram of the preserved fruit preparation 25-300 mmoles of dissolved acetate in the form of dissolved acetic acid and acetate anion.

14. The method according to claim 1, wherein 100 parts by weight of the non-preserved fruit composition are combined with 0.5 to 10 parts by weight of the acetate buffer.

15. The method according to claim 1, wherein the non-sugar fruit material originates from fruit selected from apple, cherry, banana, grape, lemon, lime, orange, mango, apricot, pineapple, blueberry, strawberry, raspberry, mulberry, blackcurrant, redcurrant, plum, fig, pear, mandarin, grapefruit, peach, passion fruit, melon, kiwi, guava, pawpaw, coconut, litchi and combinations thereof.

16. The method according to claim 1, wherein the non-preserved fruit composition comprises at least 30 wt. % of fruit pieces having a weight of at least 0.1 gram.

17. The method according to claim 1, wherein the non-preserved fruit composition comprises 40-90% by weight of dry matter of sugar selected from fructose, glucose, sucrose and combinations thereof and 10-60% by weight of dry matter of non-sugar dry fruit matter.
